(19) United States
(12) Patent Application Publication
(10) Pub. No.: US 2007/0012320 A1
(43) Pub. Date: Jan. 18, 2007

(54) Hair loss questionnaire system and method

(76) Inventors: Olivier De Lacharriere, Paris (FR); Tiphaine Vuillet, Paris (FR); Philippe Bastien, Charenton le Pont (FR)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/354,003

(22) Filed: Feb. 15, 2006

Related U.S. Application Data
(60) Provisional application No. 60/652,729, filed on Feb. 15, 2005.

(51) Int. Cl. G06F 19/00

(52) U.S. Cl. 128/898; 705/3

(57) ABSTRACT

Methods and systems for diagnosing and quantifying a degree of severity of hair loss. In accordance with one implementation, a method is provided that includes the steps of determining a client's gender, presenting to the client a first set of gender-tailored questions for diagnosing hair loss, and determining whether the client suffers from (a) significant hair loss or (b) less significant hair loss based on the client's answers to the first set of questions. If the client is determined to suffer from significant hair loss, the client is diagnosed with severe hair loss. Alternatively, the method proceeds to the steps of presenting to the client a second set of gender-tailored questions for diagnosing hair loss, and determining whether the client suffers from (c) moderate hair loss or (d) slight hair loss based on the client's answers to the second set of questions.

### RELATED APPLICATION

This application claims the benefit of U.S. Provisional Patent Application No. 60/652,729, filed Feb. 15, 2005, the disclosure of which is incorporated herein by reference.

### FIELD OF THE INVENTION

This invention relates to systems and methods for diagnosing and quantifying the severity of hair loss, in both men and women, and proposing hair loss treatment appropriate for each degree of severity.

### BACKGROUND OF THE INVENTION

At any one time, about ten percent of the hair on a human scalp is in a resting phase. After two to three months, the resting hair falls out and new hair starts to grow in its place. This growing phase generally lasts for two to six years. Each hair grows approximately one centimeter per month during this phase. About ninety percent of the hair on your scalp is growing at any one time. It is normal to shed some hair each day as part of this cycle. However, some people may experience excessive, or more than normal, hair loss. Excessive hair loss can affect men, women and children.

Hair loss, or in a more severe form, baldness, may be the result of heredity, certain medications, or an underlying medical condition. For example, hormonal problems may cause hair loss. One's hair may fall out as a result of an overactive or underactive thyroid gland. This hair loss usually can be mitigated or even reversed by treatment of the thyroid disease. Hair loss may occur if male or female hormones, known as androgens and estrogens, are out of balance. Correcting the hormone imbalance may stop hair loss.

Some medicines may cause hair loss. This type of hair loss improves when one stops taking the medicine. Medicines that may cause hair loss include blood thinners (e.g., anticoagulants), medicines used to treat gout, medicines used in chemotherapy to treat cancer, vitamin A (if taken in excess amount), birth control pills, and antidepressants. Certain infections may cause hair loss. For example, fungal infections of the scalp may cause hair loss in children.

Heredity may cause hair loss. For example, male-pattern baldness is the most common cause of hair loss in men. Men who have this type of hair loss usually have inherited the trait. Men who start losing their hair at an early age tend to develop more extensive baldness. In male-pattern baldness, hair loss typically results in a receding hair line and baldness on the top of the head.

Hair loss may also occur as part of an underlying disease, such as lupus or diabetes. Because hair loss may be an early sign of a disease, it is important to find the cause so that the disease can be treated.

Depending on the type of hair loss, treatments are available, including topical lotions (e.g., Rogaine™), oral pills (e.g., Propecia™), hair transplants, hair replacements, modification of lifestyle (e.g., diet, rest, medication), and the like. If a medicine is causing hair loss, the solution may be to substitute with the culprit medicine with another medicine. Recognizing and treating an infection may help stop the hair loss. Correcting a hormone imbalance may prevent further hair loss. However, hair loss may indicate one or more underlying diseases, disorders, and/or other health issues and problems.

Accordingly, the present invention provides systems and methods for diagnosing and quantifying the severity of hair loss that overcome the deficiencies of known systems.

### SUMMARY OF THE INVENTION

In accordance with one implementation, a method is provided that comprises the steps of providing a first set of questions related to hair loss, answers to each of the questions, and a score assigned to each of the answers, wherein the first set of questions comprises at least one question relating to (i) amount of hair loss during night, (ii) amount of hair loss during day, or (iii) persistence of hair loss over time and receiving answers to the first set of questions from a client. The method may further comprise determining whether the client has significant hair loss or less significant hair loss based on at least one of the received answers to the first set of questions, and if it is determined that the client has less significant hair loss, providing a second set of questions related to hair loss to the client, receiving answers to the second set of questions from the client, and determining whether the client has moderate hair loss or slight hair loss based on at least one of the received answers to the second set of questions.

In accordance with one implementation, a system is provided that comprises a first providing component for providing a first set of questions related to hair loss, answers to each of the questions, and a score assigned to each of the answers, wherein the first set of questions comprises at least one question relating to (i) amount of hair loss during night, (ii) amount of hair loss during day, or (iii) persistence of hair loss over time and a first determining component for receiving answers to the first set of questions from a client, and a first determining component for receiving answers to the first set of questions from a client and determining whether the client has significant hair loss or less significant hair loss based on at least one of the received answers to the first set of questions. The system may further comprise a diagnostic component for providing a second set of questions related to hair loss to the client and receiving answers to the second set of questions from the client based on a determination that the client has less significant hair loss and a second determining component for determining whether the client has moderate hair loss or slight hair loss based on at least one of the received answers to the second set of questions.

Additional aspects of the invention will be set forth in part in the description which follows, and in part will be obvious from the description, or may be learned by practice of the invention. Many of the objects and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate embodiments of the invention and together with the description, serve to explain the principles of the invention. In the drawings,

FIG. 1 is a block diagram of an exemplary embodiment of a network structure according to the present invention;

FIG. 2 is a block diagram of another exemplary embodiment of a network structure according to the present invention;

FIG. 3 is a block diagram of a server according to an exemplary embodiment of the present invention;

FIG. 4 is a flow chart of a process associated with questionnaire and diagnostic modules according to an exemplary embodiment of the present invention;

FIGS. 5A-B show exemplary representations of a male-specific hair loss questionnaire;

FIGS. 6A-B show exemplary representations of a female-specific hair loss questionnaire; and

FIGS. 7A-B show exemplary ascending hierarchical classifications of questionnaire test values on factorial axes.

### DETAILED DESCRIPTION

Reference will now be made in detail to the present embodiments of the invention, examples of which are illustrated in the accompanying drawings. Wherever possible, the same reference numbers will be used throughout the drawings to refer to the same or like parts.

Systems and methods consistent with the present invention manage various aspects of hair loss diagnostic and treatment proposal. For example, systems and methods consistent with the present invention may enable a cosmetic company or other entity to determine and gather data on potential clients' degree of severity of hair loss. Systems and methods consistent with the present invention may also enable a cosmetic company or other entity to promote the sales of hair loss products (e.g., products for treating anti-hair loss, for promoting the growth and increasing the strength of hair, and the like) by providing potential clients with hair loss diagnosis and propose treatments based on the diagnosis. An exemplary embodiment of the present invention includes a method and a system with components for providing sets of descriptive questions related to hair loss and diagnosing and quantifying the potential clients' degree of severity of hair loss based on answers to the sets of descriptive questions.

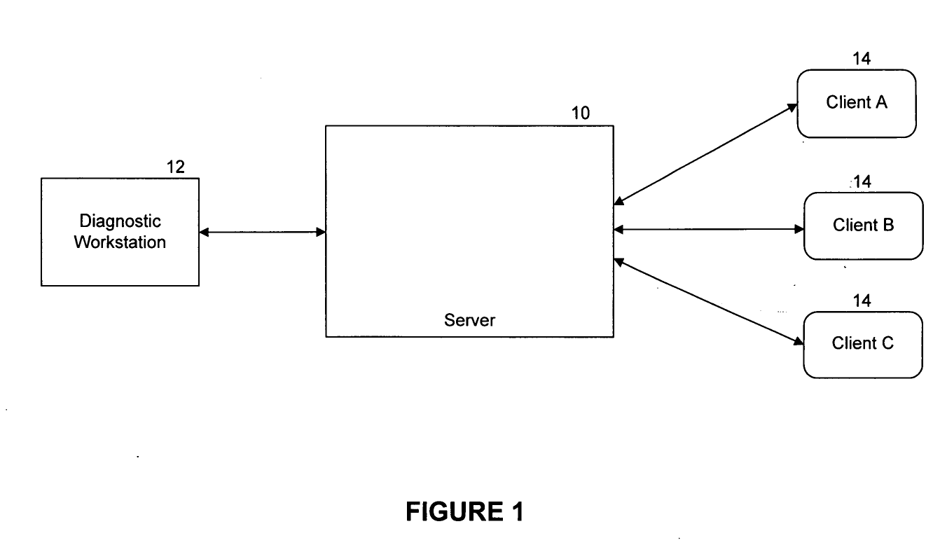

FIG. 1 is a block diagram of a system consistent with an embodiment of the present invention. A server 10 may be provided to perform one or more of the functions described above. Generally speaking, server 10 is formed by one or more data processing systems, such as computers, configured to perform functions and operations on behalf of, or in response to requests from, one or more clients, such as a user of one of client computers 14.

Server 10 may be connected to one or more client computers 14 via any type of network, e.g., an intranet, the Internet, LAN, WAN, or a modem. Using the connection, server 10 may request, send, and receive data, such as data associated with hair loss questionnaires, from the one or more client computers 14. Server 10 may also be connected to one or more diagnostic workstations 12 for providing hair loss questionnaires and diagnosis based on answers to the questionnaires via any type of network, e.g., an intranet, the Internet, LAN, WAN, or a modem. For example, server 10 may be provided by a service provider and diagnostic workstation 12 may enable a diagnosis provider, such as employees of a cosmetic company (e.g., hair loss market researchers and hair loss product salespeople), to manage data associated with hair loss questionnaires.

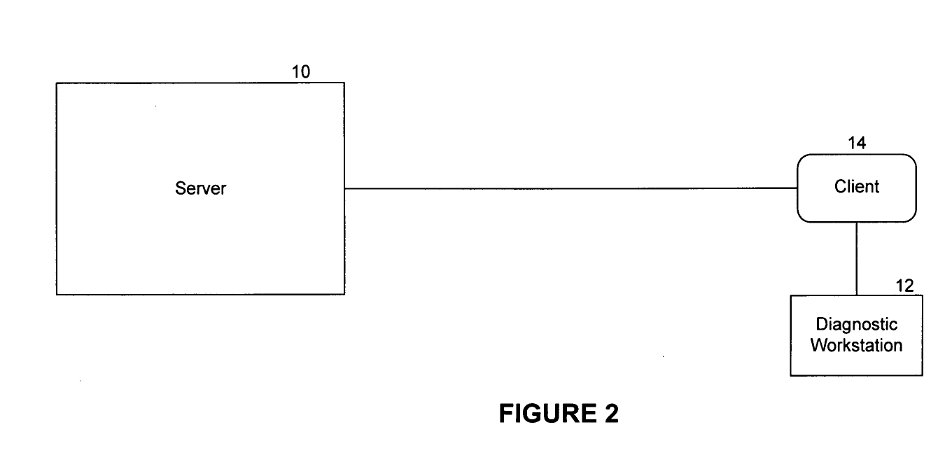

FIG. 2 is a block diagram of a system consistent with another embodiment of the present invention. In this embodiment, server 10 may be connected to one or more client computers 14 accessed by clients, e.g., potential users of hair loss products or participants in a hair loss survey from the cosmetic company. The diagnosis provider may manage hair questionnaires at one or more workstations 12 connected to client computers 14 as shown in FIG. 2. Alternatively, workstations 12 may be connected to a network, such as the Internet, and may use web browsers to access server 10.

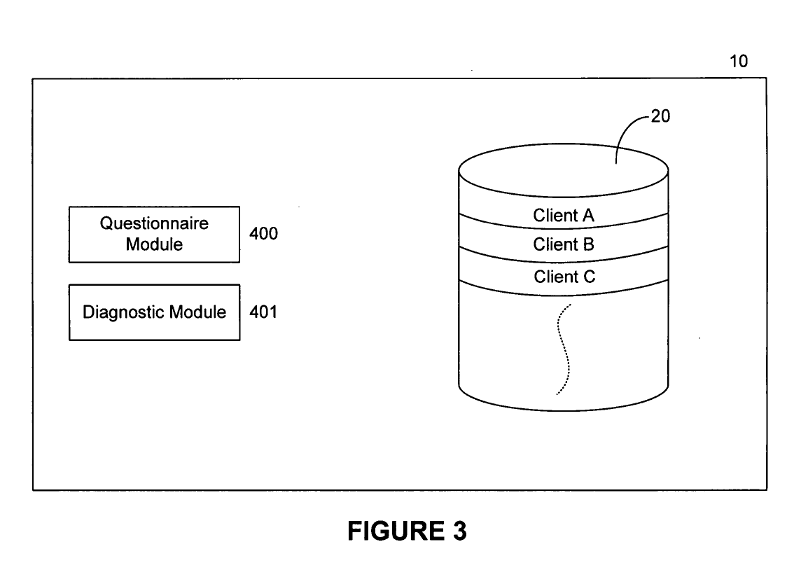

FIG. 3 is a block diagram of server 10 in greater detail. Server 10 may include, for example, a client database 20 for storing information in a computer memory related to one or more clients. For example, clients A, B, and C may be clients of a service provider running server 10 who are also potential users of hair loss products or participants in a hair loss survey from the cosmetic company. Client information may include, for example, the client's identification, gender, age, race, hair type, hair color, prior use of hair loss products, and other pertinent data associated with a client. Alternatively, information related to each client may be stored in a separate database.

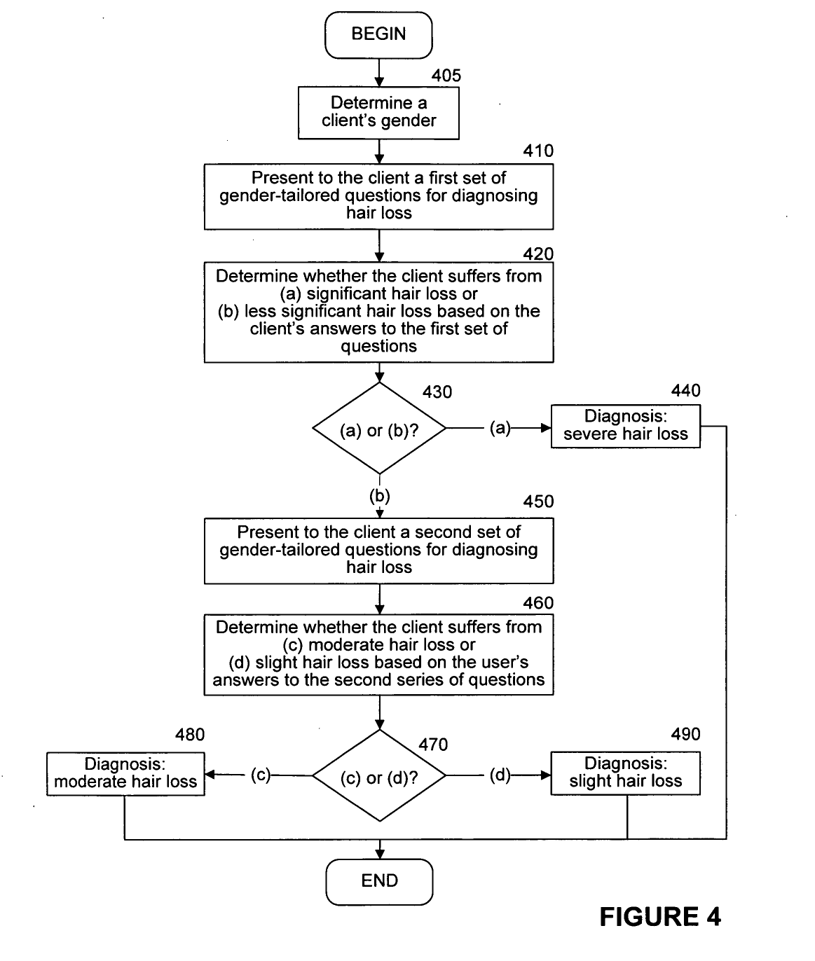

Server 10 may further include elements such as a questionnaire module 300 and a diagnostic module 400. Modules are formed of one or more computer programs configured to perform a set of operations. One or more computer associated with server 10 may, for example, execute computer programs of these modules. Questionnaire module 400 and diagnostic module 401 are described below with reference to FIG. 4. Consistent with the present invention, each module 400 and 401 may be resident on a separate computer or the modules may be combined, for example, in one or a few computers.

One skilled in the art will appreciate that server 10 may include one, all, or fewer than all of these modules consistent with the present invention. For example, a service provider may provide only questionnaire and diagnostic services to one client, only treatment proposals to a second client, and a combination of questionnaire, diagnostic, and treatment proposal to a third client.

Questionnaire and Diagnostic Modules

When the client requests a hair loss diagnosis, or when the client responds to a hair loss questionnaire, server 10 may provide the hair loss questionnaire and/or diagnose the client's hair loss based on answers to the hair loss questionnaire.

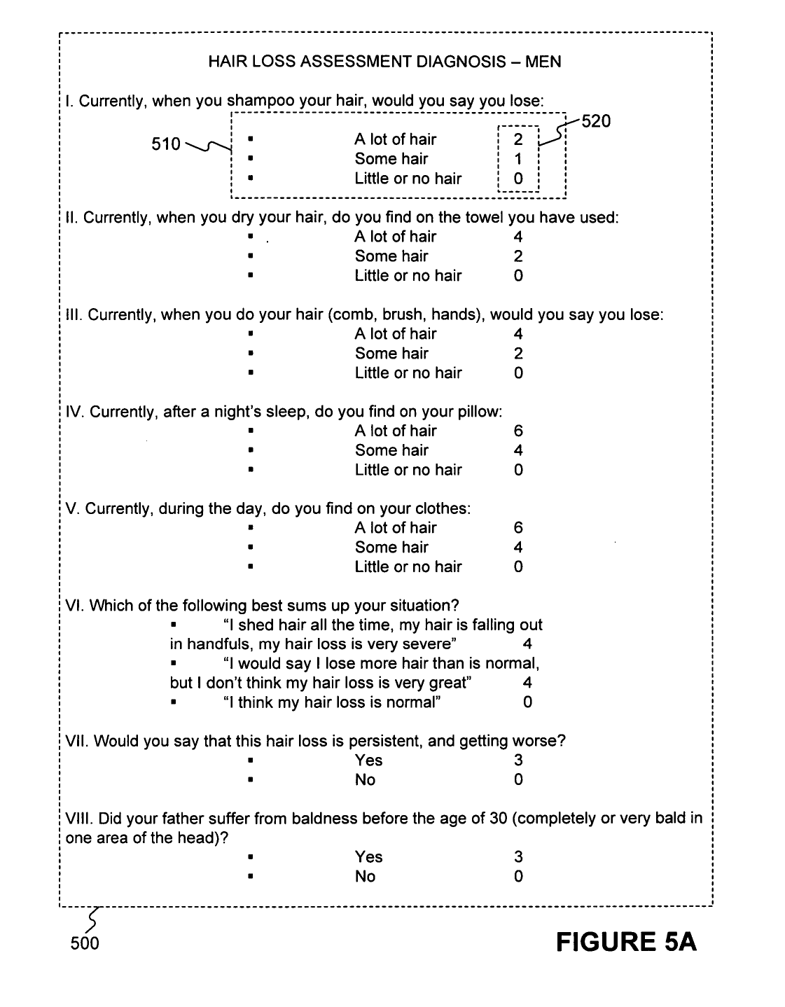

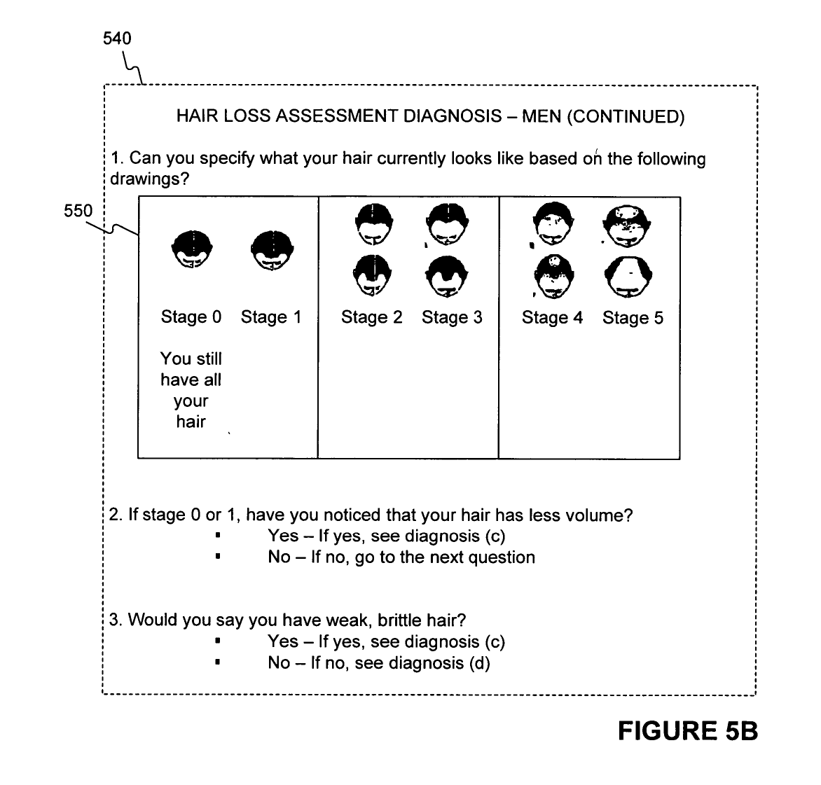

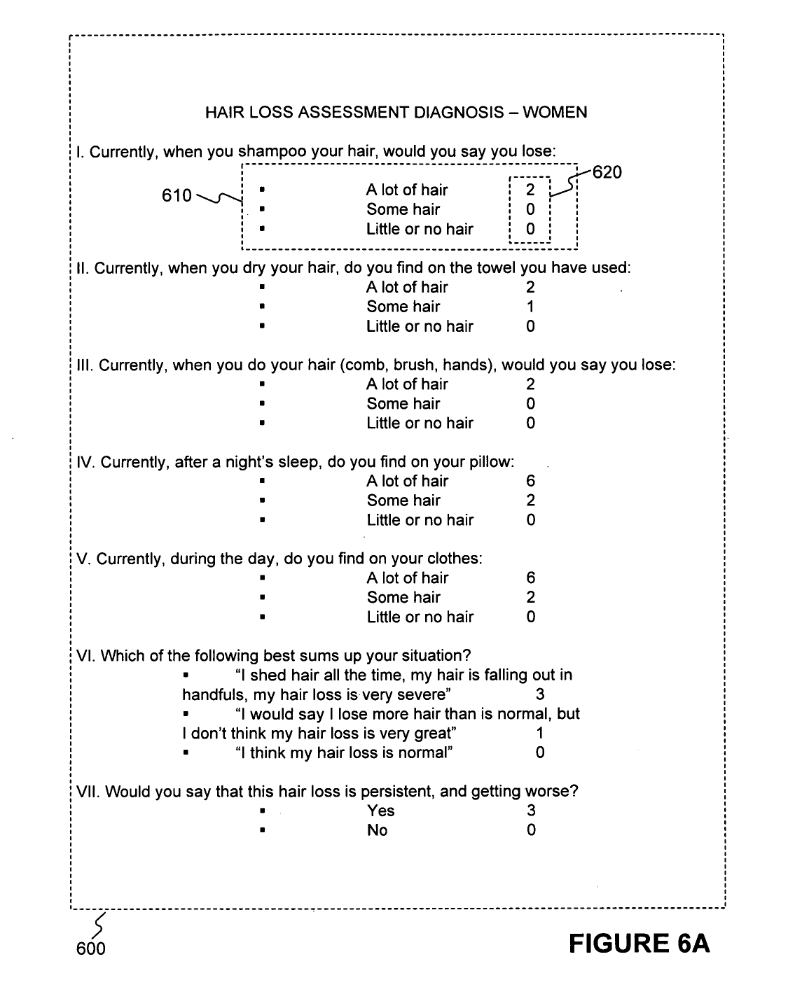

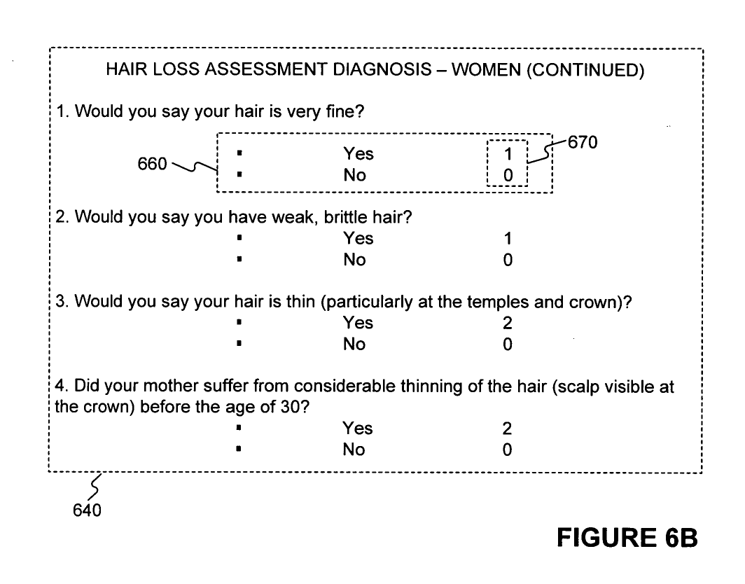

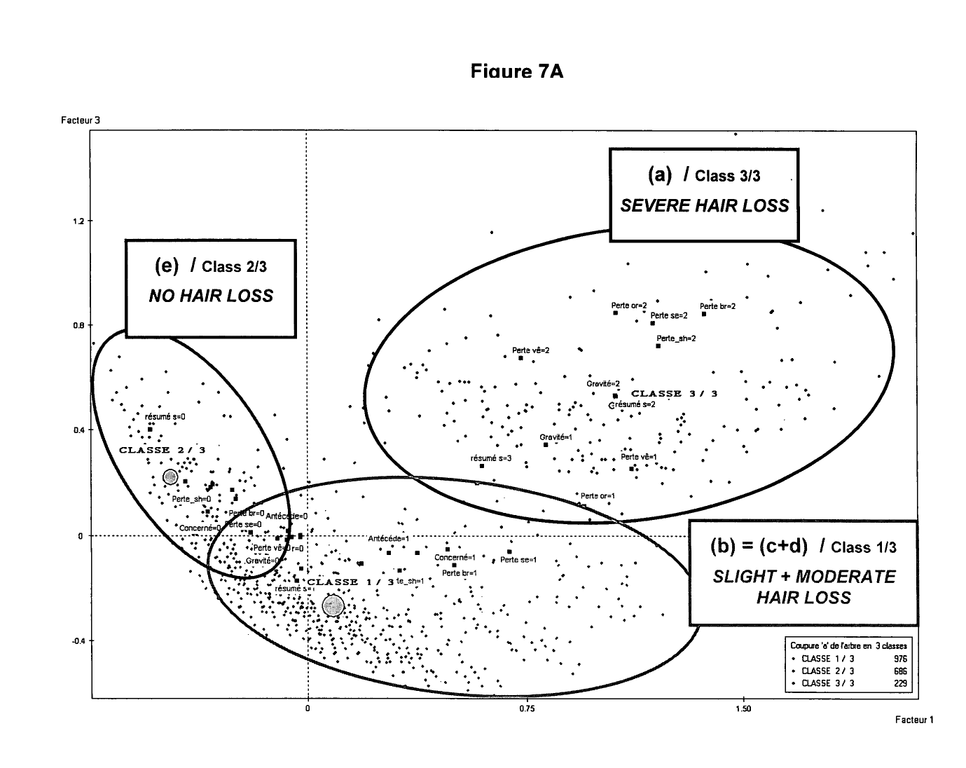

FIG. 4 is a flow chart representing an overview of a process used by questionnaire module 400 and diagnostic module 401 to diagnose and quantify the client's degree and severity of hair loss. Server 10 may first determine the client's gender and other profile data from the client's information or by asking the client (step 405). Questionnaire module 400 may provide the client (e.g., a user of client computers 14) with a hair loss questionnaire (step 410). The questionnaire may be tailored according to the client's gender and other profile data. For example, if server 10 determines that the client is male, then questionnaire module 400 may provide the client a male-specific hair loss questionnaire 500 as illustrated in FIG. 5A. Alternatively, if server 10 determines that the client is female, then questionnaire module 400 may provide the client a female-specific hair loss questionnaire 600 as illustrated in FIG. 6A.

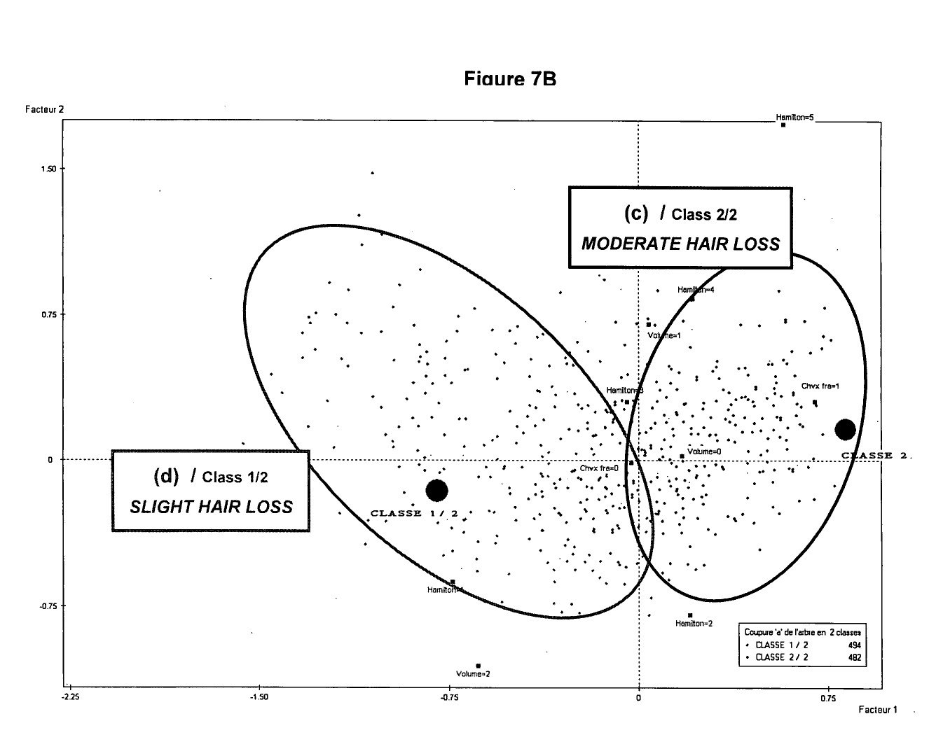

Each questionnaire (e.g., questionnaire 500 or 600) may include one or more questions (e.g., questions I-VIII in questionnaire 500, questions I-VII in questionnaire 600). Each question may have one or more associated answers (e.g., answers 510), and each answer may have a corresponding numerical value (e.g., scores 520). Categories of hair loss severity (e.g., slight hair loss, moderate hair loss, severe hair loss, etc) may be created based on statistical analysis of test values resulting from answers to the questions. For example, a factor analysis of multiple correspondence may be carried out based on the test values, followed by an ascending hierarchical classification on factorial axes, as illustrated in FIGS. 7A and 7B. The categories may be characterized based on the test values, corresponding to the expression of the differences observed, for one form of the studied variable, between the percentages of that form in each of the categories and in the general population, for example, as standard deviation of a normal distribution.

Based on the client's response to the questions in the hair loss questionnaire (e.g., questionnaire 500 or 600), diagnostic module 401 determines whether the client suffers from (a) significant hair loss or (b) less significant hair loss (step 420). Diagnostic module 401 may make the determination in step 420 by, for example, combining the numerical values (e.g., scores 520) for each of the answers in accordance to the client's response to the questionnaire (step 430). If diagnostic module 401 determines that the client is suffering from (a) significant hair loss (step 430 “(a)”), for example, if the sum of the numerical values is greater than or equal to a specified threshold (e.g., 10) for significant hair loss, diagnostic module 401 provides a “severe hair loss” diagnosis to the client (step 440) and may propose treatment options to the client. A treatment option may include, for example, one or more product recommendations (e.g., cosmetic product recommendations for products to treat diagnosed conditions of the subject), remedial measures, preventative measures, predictions, prognoses, price and availability information, application and use information, suggestions for complementary products, lifestyle or dietary recommendations, or any other information intended to aid the subject in a course of future conduct. A treatment option may also include providing information and treatment options specific to the client based on the client's answers, referring the client to a hair loss specialist and/or doctor, and the like.

Alternatively, if diagnostic module 401 determines that the client is suffering from (b) less significant hair loss (step 430 “(b)”), for example, if the sum of the numerical values is less than a specified threshold for significant hair loss, diagnostic module 401 may request that questionnaire module 400 provide the client with a second set of question or questions from the hair loss questionnaire (step 450). The second set of question or questions may also be tailored according to the client's gender and other profile data. For example, questionnaire module 400 may provide to a male client a male-specific set of questions 540 as illustrated in FIG. 5B (step 450). Alternatively, questionnaire module 400 may provide to a female client a female-specific set of questions 640 as illustrated in FIG. 6B.

Based on the client's response to the questions in the second set of questions (e.g., questions 540 or questions 640), diagnostic module 401 determines whether the client suffers from (c) moderate hair loss or (d) slight hair loss (step 460). Diagnostic module 401 may make the determination in step 460 by, for example, combining the numerical values (e.g., scores 670) for each of the answers (e.g., answer 660) in accordance to the client's response to the questionnaire (step 470).

Diagnostic module 401 may also make the determination in step 460, for example, in direct response to the client's answer to questions 540. For instance, if the client selects stages 2, 3, 4, or 5 in response to a hair loss chart 550, diagnostic module 401 may determine that the client is suffering from (c) moderate hair loss (step 470). However, if the client selects stages 0 or 1 in response to hair loss chart 550, diagnostic module may determine that the client is suffering from (c) moderate hair loss based on the client's affirmative answer to any of the remaining questions, or that the client is suffering from (d) slight hair loss based on the client's negative answer to the remaining questions (step 470).

If diagnostic module 401 determines that the client is suffering from (c) moderate hair loss (step 470 “(c)”), diagnostic module 401 provides a “moderate hair loss” diagnosis to the client (step 480) and may propose treatment options for moderate hair loss to the client. Alternatively, if diagnostic module 401 determines that the client is suffering from (d) slight hair loss (step 470 “(d)”), diagnostic module 401 provides a “slight hair loss” diagnosis to the client (step 490) and may propose treatment options for slight hair loss to the client. Treatment options may include, for example, providing information and treatment options specific to the client based on the client's answers, referring the client to a hair loss specialist and/or doctor, and the like.

Other embodiments of the invention will be apparent to those skilled in the art from consideration of the specification and practice of the invention disclosed herein. For example, in certain embodiments, a client may be prompted by questionnaire module 400 to submit a digital photograph of the client's hair loss and the photograph may be automatically analyzed by diagnostic module 401 or manually analyzed by a hair loss specialist to assist in reaching a diagnosis. In another embodiment, questionnaire module 400 may provide the client with the hair loss questionnaire (as shown in FIGS. 5A-B or 6A-C), but does not display the scores (e.g., scores 520, 620, and 670) assigned to each of the answers (e.g., answers 510, 610, and 660).

In a further embodiment, the client may obtain a hardcopy of the hair loss questionnaire (as shown in FIGS. 5A-B or 6A-C), completes and mails the questionnaire, and an operator at server 10 enters the client's answers for the client. In yet another embodiment, a hair loss specialist may use the hair loss questionnaire (as shown in FIGS. 5A-B or 6A-C) while interviewing a client in person or over the phone, and answers the questionnaire in accordance to the client's responses. In certain embodiments, a cosmetic company or other entity my use the hair loss questionnaire to promote the sales of its hair loss products (e.g., anti-hair loss products for promoting the growth and increasing the strength of hair, and the like) by providing clients with hair loss diagnosis and propose treatments based on the diagnosis. Embodiments consistent with the present invention may be carried out by or via any channel of communication, such as by a salesperson directly at the point of sale of hair loss or other cosmetic products, by radio and/or television (e.g., commercials, talk shows, product promotions, product placement, and other forms of mass media), via written documents (e.g., newspapers, periodicals, publications, journals, newsletters, leaflets, and other forms of mass media), or via the Internet or any other suitable computer network. In certain embodiments, such a promotion method may be carried out directly on the product, e.g., on the packaging or on an accompanying leaflet. Visual images (e.g., photographs, videos, graphics, and the like) may be used in association with such promotions to, for example, illustrate the potential effects of the promoted products. It is intended that the specification and examples be considered as exemplary only, with a true scope and spirit of the invention being indicated by the following claims.

We claim:

1. A method for diagnosing and quantifying severity of hair loss, comprising:
providing a first set of questions related to hair loss, answers to each of the questions, and a score assigned to each of the answers, wherein the first set of questions comprises at least one question relating to (i) amount of hair loss during night, (ii) amount of hair loss during day, or (iii) persistence of hair loss over time;
receiving answers to the first set of questions from a client;
determining whether the client has significant hair loss or less significant hair loss based on at least one of the received answers to the first set of questions; and
if it is determined that the client has less significant hair loss,
providing a second set of questions related to hair loss to the client;
receiving answers to the second set of questions from the client; and
determining whether the client has moderate hair loss or slight hair loss based on at least one of the received answers to the second set of questions.

2. The method of claim 1, wherein providing the second set of questions further comprises:
determining a gender of the client;
if it is determined that the gender of the client is male, providing a hair loss chart containing a plurality of stages of male hair loss.

3. The method of claim 2, wherein providing the hair loss chart further comprises:
determining whether the client has moderate hair loss or slight hair loss based at least one of the received selection of one of the stages in the hair loss chart;
if it is determined that the client has moderate hair loss, providing a proposed treatment for a diagnosis of a moderate degree of severity of hair loss to the client; and
if it is determined that the client has slight hair loss, providing a proposed treatment for a diagnosis of a low degree of severity of hair loss to the client.

4. The method of claim 1, wherein determining whether the client has moderate hair loss or slight hair loss further comprises:
if it is determined that the client has moderate hair loss, providing a proposed treatment for a diagnosis of a moderate degree of severity of hair loss to the client; and
if it is determined that the client has slight hair loss, providing a proposed treatment for a diagnosis of a low degree of severity of hair loss to the client.

5. The method of claim 1, wherein providing the first set of questions further comprises:
determining a gender of the client; and
if it is determined that the gender of the client is male, providing in the first set of questions, at least one question relating to baldness in at least one parent of the client.

6. The method of claim 1, wherein providing the second set of questions further comprises:
determining a gender of the client; and
if it is determined that the gender of the client is female, providing in the second set of questions, at least one question relating to hair thinning in at least one parent of the client.

7. The method of claim 1, wherein determining whether the client has significant hair loss or less significant hair loss further comprises:
if it is determined that the client has significant hair loss, providing a proposed treatment for a diagnosis of a high degree of severity of hair loss to the client.

8. The method of claim 1, wherein determining whether the client has significant hair loss or less significant hair loss further comprises:
calculating a hair loss value based on scores assigned to the received answers to the first set of questions; and
comparing the hair loss value to a threshold value.

9. A method for promoting sales of a cosmetic product, comprising:
providing a set of questions related to hair loss to a client, each question in the set of questions having a plurality of possible answers;
receiving a response from the client including selected answers to the first set of questions;
determining a score corresponding to the selected answers; and
diagnosing a degree of hair loss of the client based on at least in part on the determined score.

10. The method of claim 9, further comprising:
if it is determined that the client has less significant hair loss,
providing a second set of questions related to hair loss to the client;
receiving answers to the second set of questions from the client; and
determining whether the client has moderate hair loss or slight hair loss based on at least one of the received answers to the second set of questions.

11. The method of claim 9, wherein the degree of hair loss of the client is selected from the group consisting of: severe hair loss, moderate hair loss, slight hair loss, and no hair loss.

12. The method of claim 9, further comprising:
proposing the cosmetic product based on the degree of hair loss of the client, the determined score, and the response received from the client.

13. A system for diagnosing and quantifying severity of hair loss, comprising:
a first providing component for providing a first set of questions related to hair loss, answers to each of the questions, and a score assigned to each of the answers, wherein the first set of questions comprises at least one question relating to (i) amount of hair loss during night, (ii) amount of hair loss during day, or (iii) persistence of hair loss over time;
a first determining component for receiving answers to the first set of questions from a client and determining whether the client has significant hair loss or less significant hair loss based on at least one of the received answers to the first set of questions;
a diagnostic component for providing a second set of questions related to hair loss to the client and receiving answers to the second set of questions from the client based on a determination that the client has less significant hair loss; and
a second determining component for determining whether the client has moderate hair loss or slight hair loss based on at least one of the received answers to the second set of questions.

14. The system of claim 13, wherein the diagnostic component further comprises:
a gender determining component for determining a gender of the client;
a chart providing component for providing a hair loss chart containing a plurality of stages of male hair loss based on a determination that the gender of the client is male.

15. The system of claim 14, wherein the chart providing component further comprises:
a third determining component for determining whether the client has moderate hair loss or slight hair loss based at least one of the received selection of one of the stages in the hair loss chart; and
a treatment proposing component for providing a proposed treatment for a diagnosis of a moderate degree of severity of hair loss to the client based on a determination that the client has moderate hair loss, and providing a proposed treatment for a diagnosis of a low degree of severity of hair loss to the client based on a determination that the client has slight hair loss.

16. The system of claim 13, wherein the second determining component further comprises:
a treatment proposing component for providing a proposed treatment for a diagnosis of a moderate degree of severity of hair loss to the client based on a determination that the client has moderate hair loss, and providing a proposed treatment for a diagnosis of a low degree of severity of hair loss to the client based on a determination that the client has slight hair loss.

17. The system of claim 13, wherein the first providing component further comprises:
a gender determining component for determining a gender of the client; and
a third providing component for providing in the first set of questions, at least one question relating to baldness in at least one parent of the client, based on a determination that the gender of the client is male.

18. The system of claim 13, wherein the diagnostic component further comprises:
a gender determining component for determining a gender of the client; and
a third providing component for providing in the second set of questions, at least one question relating to hair thinning in at least one parent of the client, based on a determination that the gender of the client is female.

19. The system of claim 13, wherein the first determining component further comprises:
a treatment proposing component for providing a proposed treatment for a diagnosis of a high degree of severity of hair loss to the client, based on a determination that the client has significant hair loss.

20. The system of claim 13, wherein the first determining component further comprises:
a calculating component for calculating a hair loss value based on scores assigned to the received answers to the first set of questions; and
a comparing component for comparing the hair loss value to a threshold value.
